(19) United States
(12) Patent Application Publication
(10) Pub. No.: US 2011/0131064 A1
(43) Pub. Date: Jun. 2, 2011

(54) INSURANCE COMPANY TERMINAL, CONTROLLING COMPANY TERMINAL, INSURANCE MANAGEMENT METHOD AND INSURANCE MANAGEMENT SYSTEM

(76) Inventors: Hirokazu SHIRADO, Kanagawa (JP); Masaki FUKUCHI, Tokyo (JP); Kunihito SAWAI, Kanagawa (JP)

(21) Appl. No.: 12/915,740

(22) Filed: Oct. 29, 2010

(30) Foreign Application Priority Data
Dec. 2, 2009 (JP) P2009-274912

(51) Int. Cl. G06Q 40/00

(52) U.S. Cl. 705/4

(57) ABSTRACT

There is provided an insurance company terminal which includes a communication unit that performs communication with a sales company terminal, a storage unit that stores an amount of insurance money settled when a user dies, a user information update unit that acquires a price of an article or service purchased by the user as a purchase price from the sales company terminal via the communication unit and causes the storage unit to store the purchase price, and a settlement processing unit that subtracts the purchase price from the amount of the insurance money stored by the storage unit.

### BACKGROUND OF THE INVENTION

1. Field of the Invention

The present invention relates to an insurance company terminal, a controlling company terminal, an insurance management method, and an insurance management system.

2. Description of the Related Art

A reverse mortgage is a mechanism by which a user periodically obtains a loan of money to live for old age by putting up the user's own house as a security while continuing to live in the user's house and the collateralized property is disposed of when the contract terminates or the user dies to pay back the loan including interests and costs theretofore in a lump sum. For example, a technology to provide a merged product combining a reverse mortgage and life annuity insurance in a tie-up between a bank and an insurance company has been disclosed (see, for example, Japanese Patent Application Laid-Open No. 2007-4651)

According to this technology, old people are enabled to receive money to live for old age for a long period and therefore, the user first applies to a bank for a reverse mortgage and puts up the user's own house as a security. At the same time, the user optionally applies for life annuity insurance. When the contract is concluded, the user yearly obtains a loan of a constant sum from the bank until the user becomes 80 years old and thereafter, the user yearly receives a pension of a constant sum from the insurance company. Lastly, when the user dies, the collateralized property is sold off to pay back the loan in a lump sum.

### SUMMARY OF THE INVENTION

However, a reverse mortgage in the related art as disclosed in Japanese Patent Application Laid-Open No. 2007-4651 assumes that a privately-owned house is put up as a security and thus, it is difficult for people who do not own their houses to use a reverse mortgage.

Moreover, for example, it is often difficult for old people to make ample use of necessary articles or services even though such people have adequate savings. Reasons therefor include the fact that old people are pensioners and it is difficult to forecast funds necessary for life in the future. Moreover, articles and services, particularly in the field of nursing care and medical care, must all be paid by the user personally if such articles or services are not certified by the nation's nursing care or medical insurance system. Therefore, it is difficult for old people to consume articles or services, particularly those to which the nursing care or medical insurance is not applied, even though old people own considerable assets.

In light of the foregoing, it is desirable to provide a novel and improved technology enabling a user to purchase articles and services with a sense of security without putting up the user's house as a security.

According to an embodiment of the present invention, there is provided an insurance company terminal which includes a communication unit that performs communication with a sales company terminal, a storage unit that stores an amount of insurance money settled when a user dies, a user information update unit that acquires a price of an article or service purchased by the user as a purchase price from the sales company terminal via the communication unit and causes the storage unit to store the purchase price, and a settlement processing unit that subtracts the purchase price from the amount of the insurance money stored by the storage unit.

The user information update unit may cause the storage unit to store part of the purchase price acquired from the sales company terminal as a partial settlement amount, and the settlement processing unit may subtract the partial settlement amount from the purchase price stored by the storage unit.

The insurance company terminal may further include a credit residual value notification unit that calculates a credit line of the user, calculate a credit residual value by subtracting the purchase price stored by the storage unit from the calculated credit line, and notify the sales company terminal of the calculated credit residual value via the communication unit.

The storage unit may store the amount of surrender value settled when the user cancels insurance and further stores a period in which the user has paid a premium as a premium paid period, and the credit residual value notification unit may calculate a value that does not exceed the amount of surrender value based on the amount of the surrender value stored by the storage unit, the premium paid period, and the partial settlement amount as the credit line.

The storage unit may further store an investment yield k, and if the credit line is Z′, the amount of the surrender value Z, the partial settlement amount Y′, and the premium paid period t, the credit residual value notification unit may calculate the credit line Z′ by a following formula (1):

Z′=(Z−Y′)×(1+k)^{t} (1)

The storage unit may further store a risk factor of the user, and the credit residual value notification unit may calculate the credit line based on the risk factor further stored by the storage unit.

The storage unit may further store survival information of a partner, which is information indicating whether a partner of the user is alive, and the credit residual value notification unit may calculate the credit line based on the survival information of the partner further stored by the storage unit.

The surrender value may be calculated based on the premium the user pays in each predetermined period and the premium pair period.

The communication unit may further perform communication with a user terminal, and the settlement processing unit may notify the user terminal of the amount obtained by subtracting the purchase price from the amount of the insurance money via the communication unit when a death notice indicating that the user has died is acquired from the user terminal via the communication unit.

The user information update unit may acquire the partial settlement amount from the sales company terminal via the communication unit, and the settlement processing unit may notify the sales company terminal of the amount obtained by subtracting the partial settlement amount from the purchase price via the communication unit.

According to another embodiment of the present invention, there is provided a controlling company terminal including a storage unit, a communication unit that performs communication with a sales company terminal and an insurance company terminal, a contract processing unit that acquires an amount of insurance money settled when a user dies from the insurance company terminal via the communication unit and causes the storage unit to store the amount of the insurance money, a user information update unit that acquires a price of an article or service purchased by the user as a purchase price from the sales company terminal via the communication unit and causes the storage unit to store the purchase price, and a settlement processing unit that subtracts the purchase price from the amount of the insurance money stored by the storage unit.

According to another embodiment of the present invention, there is provided an insurance management system including a user terminal, a sales company terminal, and an insurance company terminal. The user terminal may include a communication unit that performs communication with the sales company terminal, an input unit that accepts input of article identification information for identifying an article or a service purchased by a user, and a purchase processing unit that notifies the sales company terminal of the article identification information whose input is accepted by the input unit via the communication unit. The sales company terminal may include a communication unit that performs communication with the insurance company terminal, a storage unit storing article information in which the article identification information and a price of the article or the service identified by the article identification information are associated, and a sales processing unit that acquires the price corresponding to the article identification information from the article information and notifies the insurance company terminal of the price via the communication unit. The insurance company terminal may include a communication unit that performs communication with the sales company terminal, a storage unit that stores an amount of insurance money settled when the user dies, a user information update unit that acquires the purchase price from the sales company terminal via the communication unit and causes the storage unit to store the purchase price, and a settlement processing unit that subtracts the purchase price from the amount of the insurance money stored by the storage unit.

According to another embodiment of the present invention, there is provided an insurance management system including a user terminal, a sales company terminal, an insurance company terminal, and a controlling company terminal. The user terminal may include a communication unit that performs communication with the sales company terminal, an input unit that accepts input of article identification information for identifying an article or a service purchased by a user, and a purchase processing unit that notifies the sales company terminal of the article identification information whose input is accepted by the input unit via the communication unit. The sales company terminal may include a communication unit that performs communication with the insurance company terminal, a storage unit storing article information in which the article identification information and a price of the article or the service identified by the article identification information are associated; and a sales processing unit that acquires the price corresponding to the article identification information from the article information and notifies the insurance company terminal of the price via the communication unit. The insurance company terminal may include a communication unit that performs communication with the controlling company terminal, a storage unit that stores an amount of insurance money settled when the user dies, and a controlling company contract processing unit that notifies the controlling company terminal of the amount of the insurance money via the communication unit. The controlling company terminal may include a storage unit, a communication unit that performs communication with the sales company terminal and the insurance company terminal, a contract processing unit that acquires the amount of the insurance money from the insurance company terminal via the communication unit and causes the storage unit to store the amount of the insurance money a user information update unit that acquires the purchase price from the sales company terminal via the communication unit and causes the storage unit to store the purchase price, and a settlement processing unit that subtracts the purchase price from the amount of the insurance money stored by the storage unit.

According to the present invention, as described above, a user can purchase articles and services with a sense of security without putting up the user's house as a security.

### BRIEF DESCRIPTION OF THE DRAWINGS

FIG. 1 is a diagram showing a configuration of an insurance management system according to a first embodiment of the present invention;

FIG. 2 is a diagram showing a function configuration of a user terminal according to the first embodiment;

FIG. 3 is a diagram showing the function configuration of a sales company terminal according to the first embodiment;

FIG. 4 is a diagram showing the function configuration of an insurance company terminal according to the first embodiment;

FIG. 5 is a diagram showing a configuration example of article information held by the sales company terminal according to the first embodiment;

FIG. 6 is a diagram showing a configuration example of sales information held by the sales company terminal according to the first embodiment;

FIG. 7 is a diagram showing a configuration example of user information held by the insurance company terminal according to the first embodiment;

FIG. 8 is a graph showing an example of a credit line (maximally available amount of money) calculated by the insurance company terminal according to the first embodiment;

FIG. 9 is a sequence diagram showing the flow of processing (when a death notice is given or a cancellation request is made) performed by the insurance management system according to the first embodiment;

FIG. 10 is a sequence diagram showing the flow of processing (when a service termination request is made) performed by the insurance management system according to the first embodiment;

FIG. 11 is a diagram showing the configuration of the insurance management system according to a second embodiment of the present invention;

FIG. 12 is a diagram showing the function configuration of an insurance company terminal according to the second embodiment;

FIG. 13 is a diagram showing the function configuration of a controlling company terminal according to the second embodiment;

FIG. 14 is a diagram showing a configuration example of user information held by the insurance company terminal according to the second embodiment;

FIG. 15 is a diagram showing a configuration example of user information held by the controlling company terminal according to the second embodiment;

FIG. 16 is a sequence diagram showing the flow of processing (when a death notice is given or a cancellation request is made) performed by the insurance management system according to the second embodiment; and

FIG. 17 is a sequence diagram showing the flow of processing (when a service termination request is made) performed by the insurance management system according to the second embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The description will be provided in the order shown below:

1. First Embodiment (When No Controlling Company Terminal Is Present)
1-1. Configuration of Insurance Management System
1-2. Function Configuration of User Terminal
1-3. Function Configuration of Sales Company Terminal
1-4. Function Configuration of Insurance Company Terminal
1-5. Configuration Example of Article Information Held by Sales Company Terminal
1-6. Configuration Example of Sales Information Held by Sales Company Terminal
1-7. Configuration Example of User Information Held by Insurance Company Terminal
1-8. Example of Credit Line (Maximally Available Amount of Money) Calculated by Insurance Company Terminal
1-9. Processing Performed by Insurance Management System (Death Notice or Cancellation Request)
1-10. Processing Performed by Insurance Management System (Service Termination Request)

2. Second Embodiment (When A Controlling Company Terminal Is Present)
2-1. Configuration of Insurance Management System
2-2. Function Configuration of Sales Company Terminal
2-3. Function Configuration of Controlling Company Terminal
2-4. Configuration Example of User Information Held by Insurance Company Terminal
2-5. Configuration Example of User Information Held by Controlling Company Terminal
2-6. Processing Performed by Insurance Management System (Death Notice or Cancellation Request)
2-7. Processing Performed by Insurance Management System (Service Termination Request)

3. Modification

4. Conclusion

### 1. First Embodiment (When No Controlling Company Terminal is Present)

First, the first embodiment of the present invention will be described. In the first embodiment, an insurance company terminal calculates a credit line of a user or manages a residual value of credit thereof. When accounts are settled, an insurance company pays purchase prices of articles or services purchased from sales companies by the user to the sales companies and an amount of money calculated by subtracting the purchase prices from an insurance amount to a beneficiary.

### [1-1. Configuration of Insurance Management System]

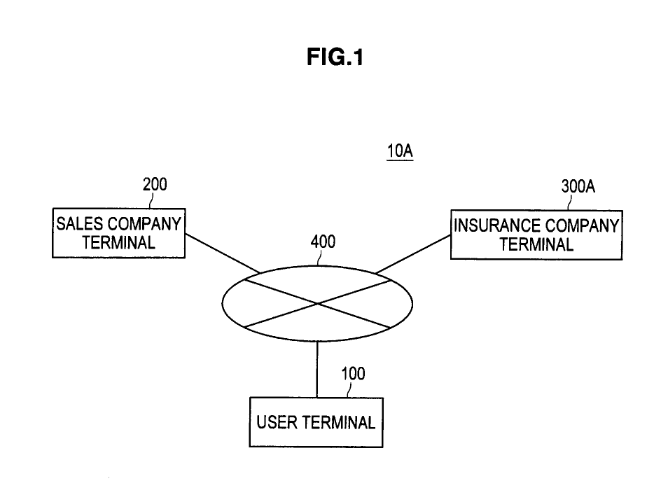

FIG. 1 is a diagram showing the configuration of an insurance management system according to the first embodiment of the present invention. The configuration of an insurance management system according to the first embodiment of the present invention will be described with reference to FIG. 1.

As shown in FIG. 1, an insurance management system 10A according to the first embodiment of the present invention includes a user terminal 100, a sales company terminal 200, and an insurance company terminal 300A. The user terminal 100, the sales company terminal 200, and the insurance company terminal 300A are, as shown, for example, in FIG. 1, connected to a network 400 and can mutually perform communication via the network 400. However, the user terminal 100, the sales company terminal 200, and the insurance company terminal 300A may be able to mutually perform communication via a leased line.

The user terminal 100 is a terminal used by a user and is installed, for example, in a user's home. However, the user terminal 100 is not limited to terminals installed in the user's home and may be a terminal installed in a place other than the user's home or a terminal that can be carried by the user.

The sales company terminal 200 is a terminal used by an employee of a sales company that does business of sales of articles or services and is installed, for example, in a place of business of the sales company. However, the sales company terminal 200 is not limited to terminals installed in the place of business of the sales company and may be a terminal installed in a place other than the place of business of the sales company or a terminal that can be carried by the employee of the sales company.

The insurance company terminal 300A is a terminal used by an employee of an insurance company that does business of insurance (for example, life insurance) service and is installed, for example, in a place of business of the insurance company. However, the insurance company terminal 300A is not limited to terminals installed in the place of business of the insurance company and may be a terminal installed in a place other than the place of business of the insurance company or a terminal that can be carried by the employee of the insurance company.

### [1-2. Function Configuration of User Terminal]

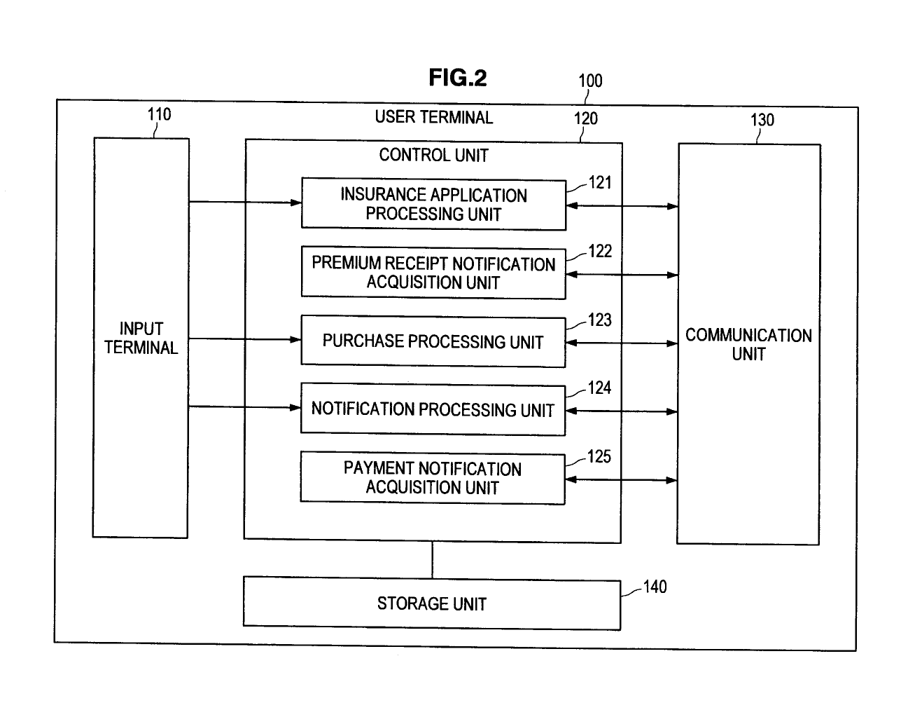

FIG. 2 is a diagram showing the function configuration of a user terminal according to the first embodiment of the present embodiment. The function configuration of a user terminal according to the first embodiment of the present embodiment will be described with reference to FIG. 2.

As shown in FIG. 2, the user terminal 100 according to the first embodiment of the present embodiment mainly includes an input unit 110, a control unit 120, a communication unit 130, and a storage unit 140.

The input unit 1 has a function of receiving input of information from the user. The input unit 1 is constituted of an input apparatus such as a keyboard, mouse, and button. However, the type of input apparatus constituting the input unit 1 is not limited to these.

The control unit 120 has a function of controlling the operation of the user terminal 100 and mainly includes an insurance application processing unit 121, a premium receipt notification acquisition unit 122, a purchase processing unit 123, a notification processing unit 124, and a payment notification acquisition unit 125. The control unit 120 is constituted of, for example, a CPU (Central Processing Unit) and RAM (Random Access Memory) and the CPU expands a program stored in an HDD (Hard Disk Drive) or semiconductor memory into the RAM and executes the program to realize the function thereof.

The insurance application processing unit 121 has a function of notifying the insurance company terminal 300A of an insurance application request via the communication unit 130. The insurance application request includes information for identifying a premium the user pays at predetermined intervals (for example, monthly) (hereinafter simply referred to as a “premium”). The insurance application processing unit 121 acquires information for identifying the premium from the user via the input unit 110 and can include the information in the insurance application request. The information for identifying the premium may be the premium itself or information for identifying the premium held by the insurance company terminal 300A.

The insurance application processing unit 121 also has a function to acquire an insurance application response from the insurance company terminal 300A via the communication unit 130. The insurance application response contains, for example, information about whether to accept the insurance application request from the user terminal 100. If information indicating that the insurance application request has been accepted is included, for example, the insurance application processing unit 121 may cause a display unit (not shown) to display the information indicating that the insurance application request has been accepted. The user who peruses the information indicating that the insurance application request has been accepted can start to pay the premium.

The premium receipt notification acquisition unit 122 has a function to acquire a premium receipt notification from the insurance company terminal 300A via the communication unit 130. For example, the premium receipt notification is made to the user terminal 100 via the insurance company terminal 300A after an employee of the insurance company confirms payment of the premium by the user.

The purchase processing unit 123 has a function to notify the sales company terminal 200 of a purchase application request via the communication unit 130. If the purchase processing unit 123 acquires information indicating purchase of an article or service sold by the sales company terminal 200 via, for example, the input unit 110 from the user, the purchase processing unit 123 notifies the sales company terminal 200 of a purchase application request.

The purchase processing unit 123 also has a function to acquire a purchase application response from the sales company terminal 200 via the communication unit 130. The purchase application response contains, for example, information indicating articles or services that can be sold to the user. For example, the purchase processing unit 123 may cause a display unit (not shown) to display information indicating an article or service contained in the purchase application response. The user who peruses information indicating an article or service can input information to select information for identifying the article or service to be purchased (hereinafter also referred to as an “article ID”) into the input unit 110.

The purchase processing unit 123 also has a function of notifying the sales company terminal 200 of a purchase contract request via the communication unit 130. The purchase contract request contains information for identifying the article or service sold by the sales company. The purchase processing unit 123 can acquire information for identifying the article or service sold by the sales company to contain the information in a purchase application request.

The purchase processing unit 123 also has a function of acquiring a purchase contract response from the sales company terminal 200 via the communication unit 130. The purchase contract response contains, for example, information about whether the purchase contract request from the user terminal 100 is accepted. If information indicating that the purchase contract request has been accepted is contained, for example, the purchase processing unit 123 may cause a display unit (not shown) to display information indicating that the purchase contract request has been accepted. The user who peruses information indicating that the purchase contract request has been accepted can wait until the purchased article or service is provided.

When information indicating cancellation of insurance is acquired from the user via the input unit 110, the notification processing unit 124 has a function of notifying the insurance company terminal 300A of a cancellation request via the communication unit 130. If, after the user dies, information indicating that the user has died is acquired from a beneficiary such as the partner or a child of the user via the input unit 110, the notification processing unit 124 has a function of notifying the insurance company terminal 300A of a death notice via the communication unit 130.

The notification processing unit 124 also has a function of receiving an insurance residual value payment notification from the insurance company terminal 300A. The insurance residual value payment notification contains an insurance residual value calculated by subtracting prices of articles or services purchased by the user from the insurance money. The insurance residual value payment notification is made to the user terminal 100 via the insurance company terminal 300A, for example, after an employee of the insurance company terminal 300A confirms payment of the insurance residual value to the beneficiary.

The communication unit 130 has a function of mainly performing communication with the sales company terminal 200 or the insurance company terminal 300A. The communication unit 130 is constituted of, for example, a communication apparatus. The type of the communication apparatus constituting the communication unit 130 is not specifically limited.

The storage unit 140 has a function of storing data or programs used by the control unit 120. The storage unit 140 is constituted of, for example, a storage apparatus such as an HDD and semiconductor memory. The type of the storage apparatus constituting the storage unit 140 is not specifically limited.

### [1-3. Function Configuration of Sales Company Terminal]

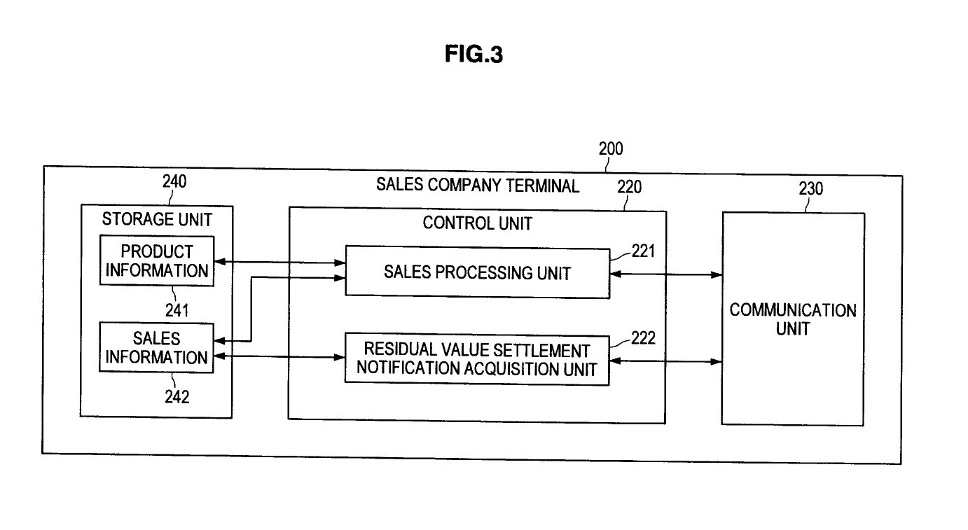

FIG. 3 is a diagram showing the function configuration of a sales company terminal according to the first embodiment of the present invention. The function configuration of the sales company terminal according to the first embodiment of the present invention will be described with reference to FIG. 3.

As shown in FIG. 3, the sales company terminal 200 according to the first embodiment of the present invention mainly includes a control unit 220, a communication unit 230, and a storage unit 240.

The control unit 220 has a function of controlling the operation of the sales company terminal 200 and mainly includes a sales processing unit 221 and a residual value settlement notification acquisition unit 222. The control unit 220 is constituted of, for example, a CPU and RAM and the CPU expands a program stored by an HDD or semiconductor memory into the RAM to execute the program to realize the function thereof.

The sales processing unit 221 has a function of acquiring a purchase application request from the user terminal 100 via the communication unit 230. After receiving a purchase application request, the sales processing unit 221 also has a function of notifying the insurance company terminal 300A of a credit residual value confirmation request via the communication unit 230. The credit residual value means remaining charges the user can use for purchasing articles or services from the insurance money. The sales processing unit 221 also has a function of acquiring a credit residual value confirmation response as a response to the credit residual value confirmation request via the communication unit 230. The credit residual value confirmation response contains the credit residual value. The sales processing unit 221 can perform sales processing to the user terminal 100 based on the credit residual value contained in the credit residual value confirmation response.

The sales processing unit 221 also has a function of notifying the user terminal 100 of a purchase application response as a response to the purchase application request via the communication unit 230. The sales processing unit 221 can contain, for example, information indicating articles or services that can be purchased by the user in the purchase application response. As information indicating articles or services that can be purchased by the user, for example, the article name of article information 241 stored in the storage unit 240 can be used.

The sales processing unit 221 can also select, for example, articles or services that can be sold at a price equal to or less than the credit residual value contained in the credit residual value confirmation response to contain article names, which are names of selected articles or services, in a purchase application response. In such a case, when a purchase contract request is received via the communication unit 230, the sales processing unit 221 may notify the user terminal 100 of a purchase contract response by registering the user terminal ID to identify the user terminal 100, the article ID contained in the purchase contract request, and the price of the article or service identified by the article ID in sales information 242 as the user terminal ID, purchased article ID, and settlement residual value respectively. As the price of the article or service, for example, the price of the article information 241 can be used.

The sales processing unit 221 may contain all article names of the article information 241 stored by the storage unit 240 in a purchase application response. In such a case, when a purchase contract request is received via the communication unit 230, the sales processing unit 221 may determine whether the price of the article or service identified by the article ID contained in the purchase contract request exceeds the credit residual value.

If the sales processing unit 221 determines that the price of the article or service identified by the article ID contained in the purchase contract request exceeds the credit residual value, the sales processing unit 221 may contain information indicating that the article cannot be purchased in a purchase contract response. If the sales processing unit 221 determines that the price of the article or service identified by the article ID contained in the purchase contract request is equal to or less than the credit residual value, the sales processing unit 221 may notify the user terminal 100 of a purchase contract response containing information indicating that the article has been purchased by registering the user terminal ID to identify the user terminal 100, the article ID contained in the purchase contract request, and the price of the article or service identified by the article ID in the sales information 242 as the user terminal ID, purchased article ID, and settlement residual value respectively.

The sales processing unit 221 also has a function of notifying the insurance company terminal 300A of a partial settlement request via the communication unit 230. The sales processing unit 221 notifies the insurance company terminal 300A of a partial settlement request by including the price of the article or service purchased by the user and the user terminal ID in the partial settlement request. The sales processing unit 221 also has a function of acquiring a partial settlement response as a response to the partial settlement request via the communication unit 230. For example, the sales company terminal 200 is notified of a partial settlement response via the insurance company terminal 300A after an employee of the insurance company confirms that part of the price of the article or service (for example, the amount corresponding to the cost of the article or service) purchased by the user has been paid to the sales company. The sales processing unit 221 also has a function of subtracting the partial settlement amount contained in the partial settlement response from the settlement residual value of the sales information 242.

Articles or services that can be purchased by the user from the sales company may be articles or services whose provision is automatically terminated immediately after the provision thereof from the sales company or may continue to be provided until the sales company is requested to terminate the provision thereof. In the latter case, if the user desires to terminate the provision of an article or service, the user notifies the sales company terminal 200 of a service termination request. In such a case, therefore, the sales processing unit 221 has a function of acquiring a service termination request indicating that the user desires to terminate the provision of an article or service from the user terminal 100 via the communication unit 230. The service termination request contains the article ID to identify the article or service whose provision should be terminated. The sales processing unit 221 notifies the insurance company terminal 300A of a partial settlement request via the communication unit 230 in each period in which a usage fee arises until a service termination request is acquired.

When the user cancels the insurance or the user dies, the residual value settlement notification acquisition unit 222 has a function of acquiring a residual value settlement notification from the insurance company terminal 300A via the communication unit 230. For example, the sales company terminal 200 is notified of a residual value settlement notification via the insurance company terminal 300A after an employee of the insurance company confirms that an amount obtained by subtracting a partial settlement amount from the price of the article or service purchased by the user has been paid to the sales company. Alternatively, the residual value settlement notification acquisition unit 222 may determine whether the total of settlement residual values for the user who has canceled the insurance or has died matches the amount paid by the sales company.

The communication unit 230 has a function of mainly performing communication with the user terminal 100 or the insurance company terminal 300A. The communication unit 230 is constituted of, for example, a communication apparatus. The type of the communication apparatus constituting the communication unit 230 is not specifically limited.

The storage unit 240 has a function of storing data or programs used by the control unit 220. The storage unit 240 is constituted of, for example, a storage apparatus such as an HDD and semiconductor memory. The type of the storage apparatus constituting the storage unit 240 is not specifically limited.

### [1-4. Function Configuration of Insurance Company Terminal]

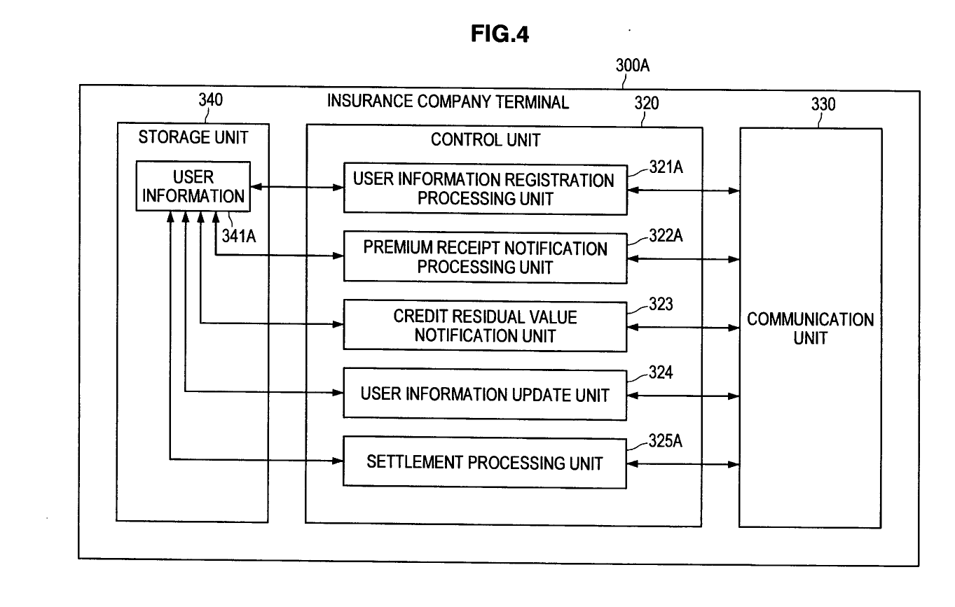

FIG. 4 is a diagram showing the function configuration of an insurance company terminal according to the first embodiment of the present invention. The function configuration of the insurance company terminal according to the first embodiment of the present invention will be described with reference to FIG. 4.

As shown in FIG. 4, the insurance company terminal 300A according to the first embodiment of the present invention mainly includes a control unit 320, a communication unit 330, and a storage unit 340.

The control unit 320 has a function of controlling the operation of the insurance company terminal 300A and mainly includes a user information registration processing unit 321A, a premium receipt notification processing unit 322A, a credit residual value notification unit 323, a user information update unit 324, and a settlement processing unit 325A. The control unit 320 is constituted of, for example, a CPU and RAM and the CPU expands a program stored by an HDD or semiconductor memory into the RAM to execute the program to realize the function thereof.

The user information registration processing unit 321A has a function of acquiring an insurance application request from the user terminal 100 via the communication unit 130. The insurance application request contains, as described above, information for identifying the premium. The user information registration processing unit 321A registers the premium contained in the insurance application request and identified by the information for identifying the premium in user information 341A. If other information is contained in the insurance application request, the user information registration processing unit 321A can also register the other information in the user information 341A. The other information includes the user terminal ID to identify the user terminal 100, age of the user, and date of taking out the insurance. The user information registration processing unit 321A can also register the insurance money in the user information 341A. If, for example, information in which the insurance money and the premium are associated is stored in the storage unit 340, the user information registration processing unit 321A can acquire the insurance money corresponding to the premium from the information for registering the insurance money in the user information 341A.

The user information registration processing unit 321A also has a function of notifying the user terminal 100 of an insurance application response via the communication unit 330. The user information registration processing unit 321A can contain, for example, information indicating whether an insurance application request from the user terminal 100 is accepted in an insurance application response. The technique used by the user information registration processing unit 321A to determine whether to accept an insurance application request from the user terminal 100 is not specifically limited. The user information registration processing unit 321A determines whether to accept an insurance application request from the user terminal 100 based on, for example, the age contained in the insurance application request.

The premium receipt notification processing unit 322A has a function of notifying the user terminal 100 of a premium receipt notification via the communication unit 330. As described above, the premium receipt notification makes a notification to the user terminal 100 via the insurance company terminal 300A after, for example, an employee of the insurance company confirms payment of the premium from the user.

The credit residual value notification unit 323 has a function of acquiring a credit residual value confirmation request from the sales company terminal 200 via the communication unit 330. When a credit residual value confirmation request is acquired, the credit residual value notification unit 323 has a function of calculating a credit line of the user. While various techniques used by the credit residual value notification unit 323 can be considered to calculate a credit line, such techniques to calculate a credit line will be described later with reference to FIG. 8.

The user information update unit 324 can, for example, acquire a partial settlement request from the sales company terminal 200 via the communication unit 330 to acquire the purchase price contained in the acquired partial settlement request. The user information update unit 324 can register the acquired purchase price in the user information 341A. The user information update unit 324 has a function of causing the storage unit 340 to store part of the purchase price acquired from the sales company terminal 200 as a partial settlement amount. If the partial settlement amount is Y′, the price of an article or service is y, and the partial settlement ratio is α, the user information update unit 324 can calculate the partial settlement amount Y′ by, for example, Formula (1) below:

Y′=αy (1)

As the partial settlement ratio α, for example, the ratio stored in the storage unit 340 may be used. If, as described above, a service termination request is necessary to terminate the provision of an article or service, the user information update unit 324 can calculate the partial settlement amount Y′ by, for example, Formula (2) below if the usage fee of an article or service for each predetermined period is yᵢ, and the partial settlement ratio for each predetermined period is αᵢ:

$$\begin{matrix}[ Expression 1 ] & \\ {Y}^{′} = {\sum }_{i = 1}^{t} {α}_{i} {y}_{i} & ( 2 )\end{matrix}$$

As the partial settlement ratio αᵢ, for example, the ratio stored in the storage unit 340 may be used. The user information update unit 324 can also notify the sales company terminal 200 of the partial settlement amount via the communication unit 330. The user information update unit 324 can also notify the sales company terminal 200 of the partial settlement amount, for example, by including the partial settlement amount in a partial settlement response.

The settlement processing unit 325A has a function of subtracting the partial settlement amount from the purchase price stored by the storage unit 340. If a death notice indicating that the user has died is acquired from the user terminal 100 via the communication unit 330, the settlement processing unit 325A may notify the user terminal 100 of an amount obtained by subtracting the purchase price from the amount of insurance money stored by the storage unit 340 via the communication unit 330. The settlement processing unit 325A can notify the user terminal 100 of an amount obtained by subtracting the purchase price from the amount of insurance money, for example, by including the amount in an insurance residual value payment notification.

If a cancellation request indicating cancellation of insurance is received from the user terminal 100 via the communication unit 330, the settlement processing unit 325A may notify the user terminal 100 of an amount obtained by subtracting the purchase price from the amount of surrender value stored by the storage unit 340 via the communication unit 330. The settlement processing unit 325A can notify the user terminal 100 of an amount obtained by subtracting the purchase price from the amount of surrender value, for example, by including the amount in an insurance residual value payment notification.

The settlement processing unit 325A may also notify the sales company terminal 200 of an amount obtained by subtracting the partial settlement amount from the purchase price via the communication unit 330. The settlement processing unit 325A can notify the sales company terminal 200 of an amount obtained by subtracting the partial settlement amount from the purchase price, for example, by including the amount in a residual value settlement notification.

The communication unit 330 has a function of mainly performing communication with the user terminal 100 or the sales company terminal 200. The communication unit 330 is constituted of, for example, a communication apparatus. The type of the communication apparatus constituting the communication unit 330 is not specifically limited.

The storage unit 340 has a function of storing data or programs used by the control unit 320. The storage unit 340 is constituted of, for example, a storage apparatus such as an HDD and semiconductor memory. The type of the storage apparatus constituting the storage unit 340 is not specifically limited.

### [1-5. Configuration Example of Article Information Held by Sales Company Terminal]

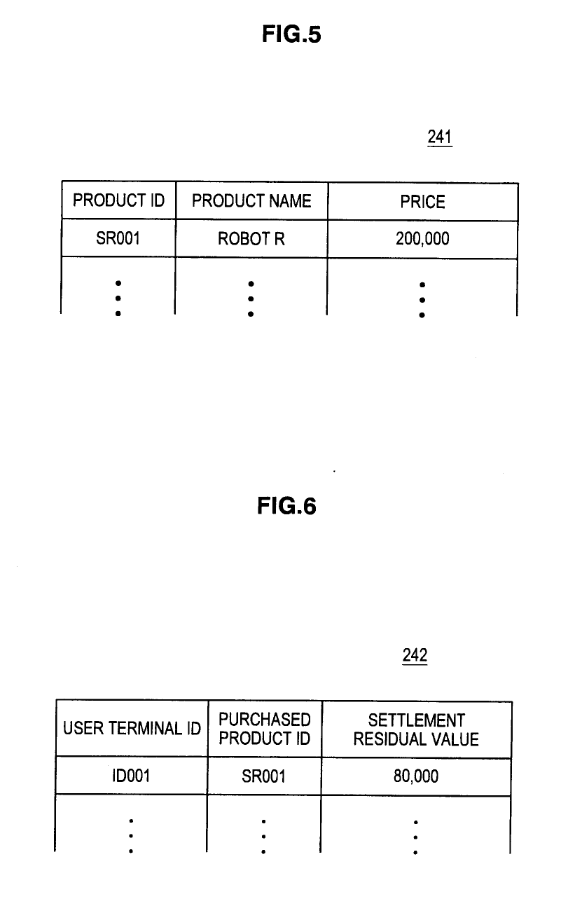

FIG. 5 is a diagram showing a configuration example of article information held by the sales company terminal according to the first embodiment of the present invention. A configuration example of article information held by the sales company terminal according to the first embodiment of the present invention will be described with reference to FIG. 5.

As shown in FIG. 5, the article information 241 held by the sales company terminal according to the first embodiment of the present invention is information in which, for example, the article ID, article name, and price are associated. However, the configuration of the article information 241 shown in FIG. 5 is only an example and the article information 241 is not limited to such an example.

### [1-6. Configuration Example of Sales Information Held by Sales Company Terminal]

FIG. 6 is a diagram showing a configuration example of sales information held by the sales company terminal according to the first embodiment of the present invention. A configuration example of sales information held by the sales company terminal according to the first embodiment of the present invention will be described with reference to FIG. 6.

As shown in FIG. 6, the sales information 242 held by the sales company terminal 200 according to the first embodiment of the present invention is information in which, for example, the user terminal ID, purchased article ID, and settlement residual value are associated. However, the configuration of the sales information 242 shown in FIG. 6 is only an example and the sales information 242 is not limited to such an example.

### [1-7. Configuration Example of User Information Held by Insurance Company Terminal]

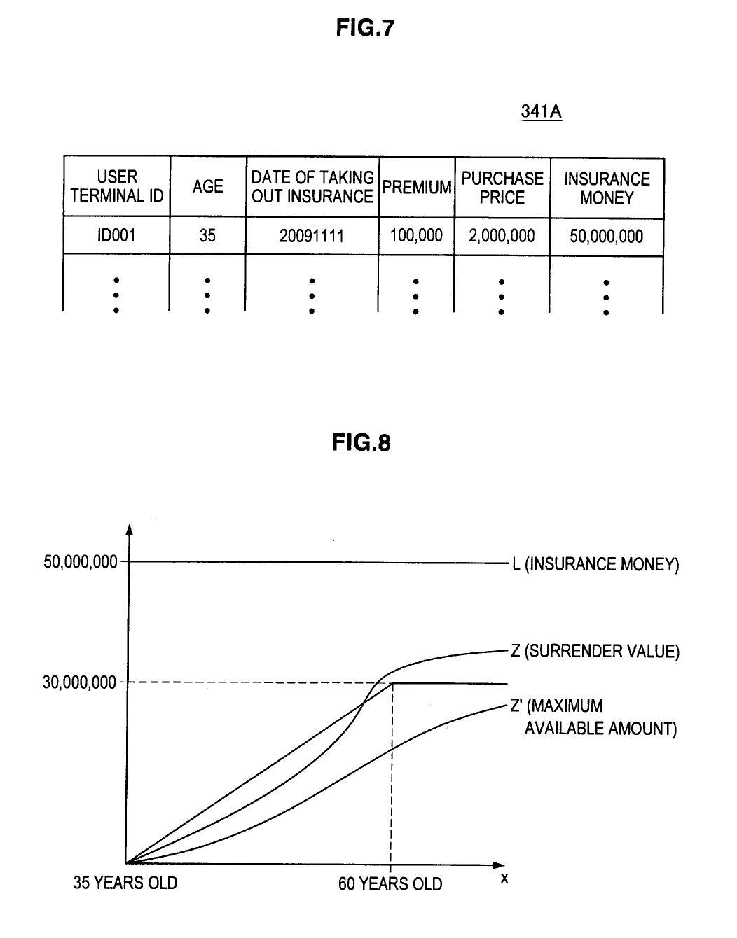

FIG. 7 is a diagram showing a configuration example of user information held by the insurance company terminal according to the first embodiment of the present invention. A configuration example of user information held by the insurance company terminal according to the first embodiment of the present invention will be described with reference to FIG. 7.

As shown in FIG. 7, the user information 341A held by the insurance company terminal according to the first embodiment of the present invention is information in which, for example, the user terminal ID, age, date of taking out insurance, premium, purchase price, and insurance money are associated. However, the configuration of the user information 341A shown in FIG. 7 is only an example and the user information 341A is not limited to such an example.

### [1-8. Example of Credit Line (Maximally Available Amount of Money) Calculated by Insurance Company Terminal]

FIG. 8 is a diagram showing an example of the credit line (maximally available amount of money) calculated by the insurance company terminal according to the first embodiment of the present invention. An example of the credit line (maximally available amount of money) calculated by the insurance company terminal according to the first embodiment of the present invention will be described with reference to FIG. 8.

In FIG. 8, the relationship among insurance money L when a user aged 35 takes out life insurance whose monthly premium is 100,000 yen, a surrender value Z, and a credit line (maximally available amount of money) Z′ is shown as an example. The surrender value Z is calculated by, for example, Formula (3) below based on a premium x the user pays in each predetermined period and a premium paid period t:

Z=f(x, t) (3)

f depends on each life insurance product and is not specifically limited. For example, an employee of the insurance company can update the premium paid period t stored in the storage unit 340 each time the user pays the premium. The insurance money L is settled when the user dies and if the premium the user pays in each predetermined period is x, the insurance money L is calculated by, for example, Formula (4) below:

L=g(x) (4)

g depends on each life insurance product and is not specifically limited. The surrender value Z is settled when the user cancels the insurance. The storage unit 340 stores the amount of surrender value and further stores the period in which the user has paid the premium as the premium paid period t and the credit residual value notification unit 323 can calculate a value that does not exceed the amount of the surrender value Z as the credit line (maximally available amount of money) Z′ based on the amount of the surrender value Z stored in the storage unit 340, the premium paid period t, and the partial settlement amount Y′. The credit line (maximally available amount of money) Z′ can be represented by Formulae (5) and (6) below:

Z′=h(Z, t, Y′) (5)

Z′≦Z (6)

If the amount available from the insurance money as a fund for the user to purchase an article or service is denoted as an available amount Y, Y is a value in the range shown by Formula (7) below:

0<Y<Z′ (7)

The storage unit 340 further stores an investment yield k and the credit residual value notification unit 323 can calculate, for example, the credit line Z′ by Formula (8) below if the credit line is Z′, the partial settlement amount is Y′, and the premium paid period is t:

Z′=(Z−Y′)×(1+k)^{t} (8)

The storage unit 340 further stores a risk factor of the user and the credit residual value notification unit 323 can calculate the credit line Z′ based on the risk factor further stored in the storage unit 340. If the risk factor is γ, the credit residual value notification unit 323 can calculate, for example, the credit line Z′ by Formula (9) below:

Z′=γ(Z−Y′)×(1+k)^{t} (9)

If, for example, the risk of the user is high, it is difficult to make the credit line Z′ relatively large and thus, the risk factor γ may be set relatively low. If the risk of the user is low, the credit line Z′ can be made relatively large and thus, the risk factor γ may be set relatively high. The storage unit 340 further stores survival information of the partner, which is information indicating whether the user's partner is alive, and the credit residual value notification unit 323 can calculate the credit line Z′ based on the survival information of the partner further stored in the storage unit 340. If the survival information of the partner is β, the credit residual value notification unit 323 can calculate, for example, the credit line Z′ by Formula (10) below. The risk factor γ of the user is stored in the storage unit 340 by, for example, being input into the insurance company terminal 300A by an employee of the insurance company.

Z′=β(Z−Y′)×(1+k)^{t} (10)

If, for example, the partner is alive, it is necessary to leave the insurance money for the partner and it is difficult to make the credit line Z′ relatively large and thus, the survival information of the partner β may be set relatively low. If the partner is not alive, it is not necessary to leave the insurance money for the partner and the credit line Z′ can be made relatively large and thus, the survival information of the partner β may be set relatively high. The value of the survival information of the partner β is updated by the insurance company terminal 300A when, for example, information indicating that the partner is no longer alive is received from the user terminal 100.

### [1-9. Processing Performed by Insurance Management System (Death Notice or Cancellation Request)]

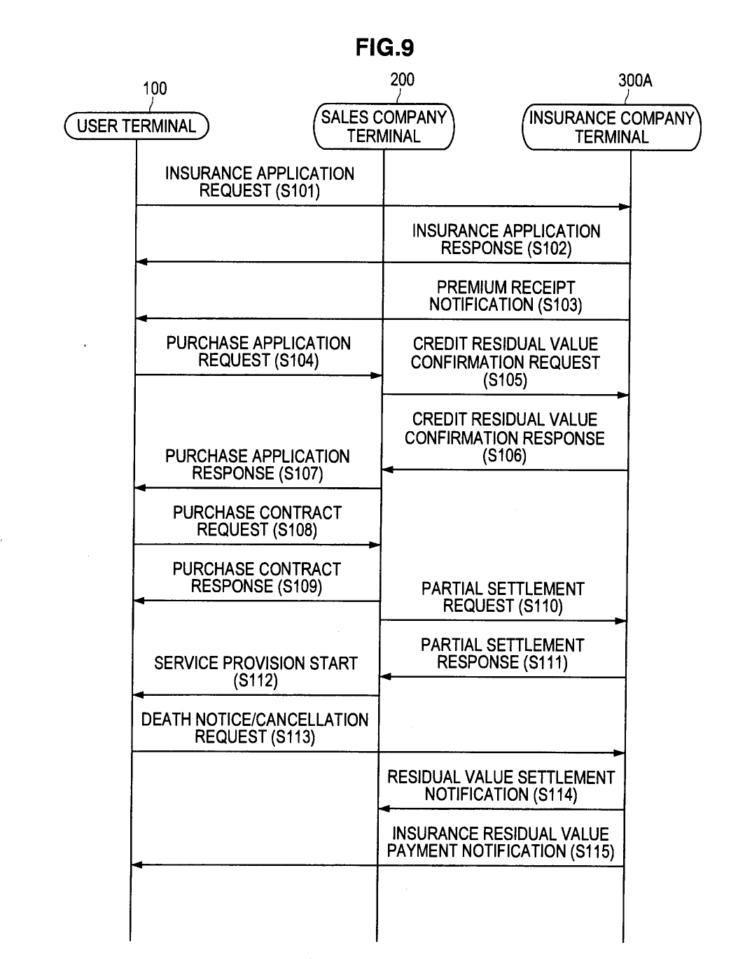

FIG. 9 is a sequence diagram showing the flow of processing (a death notice or cancellation request) performed by the insurance management system according to the first embodiment of the present invention. The processing (a death notice or cancellation request) performed by the insurance management system according to the first embodiment of the present invention will be described with reference to FIG. 9.

As shown in FIG. 9, the insurance application processing unit 121 of the user terminal 100 notifies the insurance company terminal 300A of an insurance application request (step S101) via the communication unit 130. The user information registration processing unit 321A of the insurance company terminal 300A acquires the insurance application request via the communication unit 330 and notifies the user terminal 100 of an insurance application response (step S102) via the communication unit 330. As described above, the insurance application response contains, for example, information whether the insurance application request from the user terminal 100 is accepted. The premium receipt notification processing unit 322A of the insurance company terminal 300A notifies the user terminal 100 of a premium receipt notification (step S103) via the communication unit 330. The premium receipt notification acquisition unit 122 of the user terminal 100 acquires the premium receipt notification via the communication unit 130.

If, for example, as described above, information indicating purchase of an article or service sold by the sales company terminal 200 is acquired from the user via the input unit 110, the purchase processing unit 123 of the user terminal 100 notifies the sales company terminal 200 of a purchase application request (step S104). After acquiring the purchase application request via the communication unit 230, the sales processing unit 221 of the sales company terminal 200 notifies the insurance company terminal 300A of a credit residual value confirmation request (step S105) via the communication unit 230.

When the credit residual value confirmation request is acquired via the communication unit 330, the credit residual value notification unit 323 of the insurance company terminal 300A checks the credit residual value of the user and notifies the sales company terminal 200 of a credit residual value confirmation response (step S106) by including the credit residual value therein via the communication unit 330. After acquiring the credit residual value confirmation response via the communication unit 230, the sales processing unit 221 of the sales company terminal 200 notifies the user terminal 100 of a purchase application response (step S107) via the communication unit 230. As described above, the purchase application response may contain article names selected by the sales processing unit 221 and indicating articles or services of prices equal to or less than the credit residual value or article names of all articles or services that can be sold by the sales company.

When the purchase application response is acquired via the communication unit 130, the purchase processing unit 123 of the user terminal 100 notifies the sales company terminal 200 of a purchase contract request (step S108) via the communication unit 130. The purchase contract request contains, for example, as described above, information for identifying the article or service selected by the user. After acquiring the purchase contract request (step S108) via the communication unit 230, the sales processing unit 221 of the sales company terminal 200 notifies the user terminal 100 of a purchase contract response (step S109) via the communication unit 230. The purchase contract response contains, for example, as described above, information whether the purchase contract request from the user terminal 100 is accepted.

The sales processing unit 221 of the sales company terminal 200 notifies the insurance company terminal 300A of a partial settlement request (step S110) via the communication unit 230. The user information update unit 324 of the insurance company terminal 300A acquires the partial settlement request via the communication unit 230. An employee of the insurance company pays part of the purchase price to the sales company as a partial settlement amount. The user information update unit 324 notifies the sales company terminal 200 of the partial settlement amount by including the amount in a partial settlement response (step S111).

The sales processing unit 221 of the sales company terminal 200 starts the service provision (step S112). It is assumed here that the service is provided to the user terminal 100 by the sales processing unit 221, but the service may be provided to the user by an employee of the sales company and the subject providing the service and the subject receiving the service can appropriately be changed depending on the type of article or service purchased by the user.

When information indicating cancellation of insurance is acquired from the user via the input unit 110, the notification processing unit 124 of the user terminal 100 notifies the insurance company terminal 300A of a cancellation request (step S113). If, after the user dies, information indicating that the user has died is acquired from a beneficiary such as the partner or a child of the user via the input unit 110, the notification processing unit 124 notifies the insurance company terminal 300A of a death notice (step S113) via the communication unit 130.

When a death notice or cancellation request is acquired from the user terminal 100 via the communication unit 330, the settlement processing unit 325A of the insurance company terminal 300A notifies the sales company terminal 200 of a residual value settlement notification (step S114) by including an amount obtained by subtracting the partial settlement amount from the purchase price therein via the communication unit 330. After acquiring the death notice from the user terminal 100 via the communication unit 330, the settlement processing unit 325A notifies the sales company terminal 200 of an insurance residual value payment notification (step S115) by including an amount obtained by subtracting the purchase price from the amount of insurance money therein via the communication unit 330. After acquiring the cancellation request from the user terminal 100 via the communication unit 330, the settlement processing unit 325A notifies the user terminal 100 of an insurance residual value payment notification (step S115) by including an amount obtained by subtracting the purchase price from the amount of surrender value therein via the communication unit 330.

### [1-10. Processing Performed by Insurance Management System (Service Termination Request)]

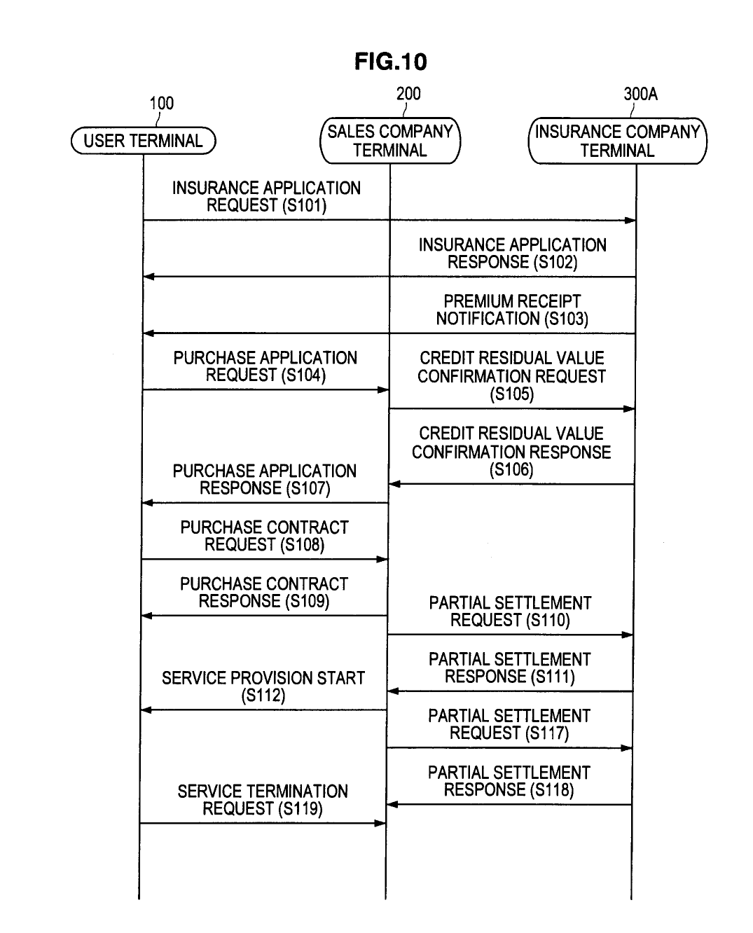

FIG. 10 is a sequence diagram showing the flow of processing (service termination request) performed by the insurance management system according to the first embodiment of the present invention. The processing (service termination request) performed by the insurance management system according to the first embodiment of the present invention will be described with reference to FIG. 10.

If, as described above, the user wishes to terminate the provision of an article or service, the user may notify the sales company terminal 200 of a service termination request via the user terminal 100. In such a case, as shown in FIG. 10, the sales processing unit 221 of the sales company terminal 200 notifies the insurance company terminal 300A of a partial settlement request (step S117) in each period in which a usage fee of an article or service arises via the communication unit 230 until a service termination request (step S119) is acquired. Each time a partial settlement request is acquired via the communication unit 230, the user information update unit 324 of the insurance company terminal 300A notifies the sales company terminal 200 of a partial settlement response (step S118) via the communication unit 330.

### 2. Second Embodiment (When a Controlling Company Terminal is Present)

Subsequently, the second embodiment of the present invention will be described. In the second embodiment, a controlling company terminal is added to an insurance management system and the controlling company terminal is in charge of calculating a user's credit line and managing a credit residual value. A controlling company pays a purchase price of an article or service purchased from the sales company by the user to the sales company and pays an amount calculated by subtracting the purchase price from insurance money to a beneficiary during settlement.

### [2-1. Configuration of Insurance Management System]

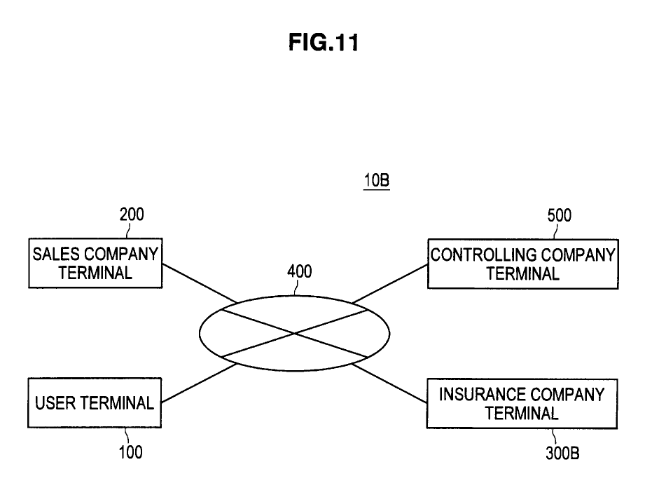

FIG. 11 is a diagram showing the configuration of the insurance management system according to the second embodiment of the present invention. The configuration of the insurance management system according to the second embodiment of the present invention will be described with reference to FIG. 11.

As shown in FIG. 11, an insurance management system 10B according to the second embodiment of the present invention includes the user terminal 100, the sales company terminal 200, an insurance company terminal 300B, and a controlling company terminal 500. The controlling company terminal 500 is also connected to, as shown, for example, in FIG. 11, the network 400 and can perform communication with the user terminal 100, the sales company terminal 200, and the insurance company terminal 300B via the network 400. However, the controlling company terminal 500 and the user terminal 100, the sales company terminal 200, or the insurance company terminal 300B may be able to mutually perform communication via a leased line.

### [2-2. Function Configuration of Sales Company Terminal]

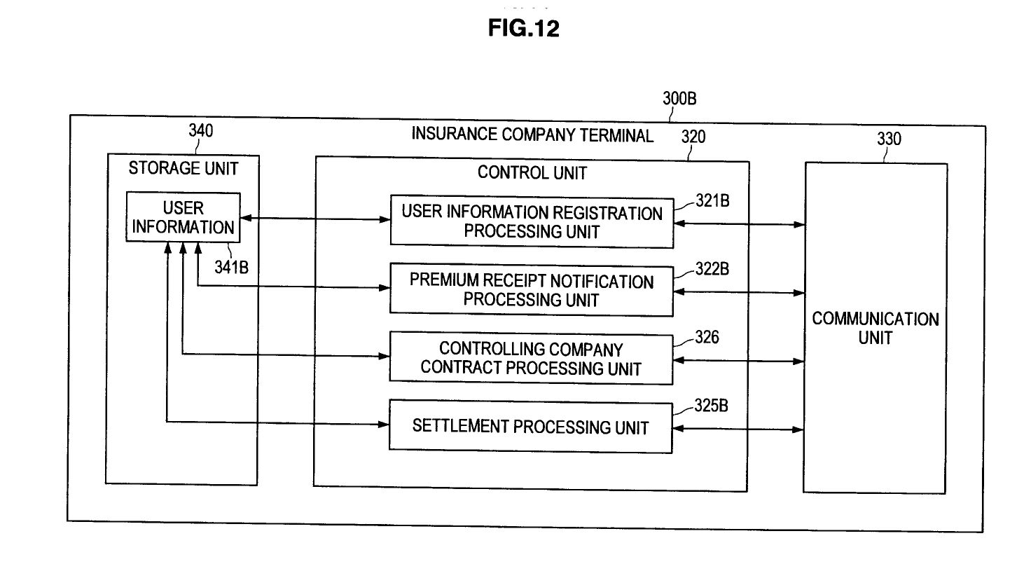

FIG. 12 is a diagram showing the function configuration of the insurance company terminal according to the second embodiment of the present invention. The function configuration of the insurance company terminal according to the second embodiment of the present invention will be described with reference to FIG. 12.

As shown in FIG. 12, the insurance company terminal 300B according to the second embodiment of the present invention is different from the insurance company terminal 300A according to the first embodiment of the present invention in that a user information registration processing unit 321B, a premium receipt notification processing unit 322B, and a settlement processing unit 325B are different from the user information registration processing unit 321A, the premium receipt notification processing unit 322A, and the settlement processing unit 325A and a controlling company contract processing unit 326 is provided. These differences of the insurance company terminal 300B according to the second embodiment of the present invention from the insurance company terminal 300A according to the first embodiment of the present invention will be described.

The user information registration processing unit 321B has the function held by the user information registration processing unit 321A according to the first embodiment and also has a function of acquiring an option application request from the user terminal 100 via the communication unit 130. The option application request may be included in an insurance application request, which is then notified from the user terminal 100, or may be notified separately from the insurance application request. The option application request contains the controlling company terminal ID to identify the controlling company terminal 500. The user information registration processing unit 321B may also register the controlling company terminal ID contained in the option application request in user information 341B.

The premium receipt notification processing unit 322B has a function of notifying the user terminal 100 and the controlling company terminal 500 of a premium receipt notification via the communication unit 330. Just like in the first embodiment, the premium receipt notification makes a notification to the user terminal 100 via the insurance company terminal 300B after, for example, an employee of the insurance company confirms payment of the premium from the user.

The controlling company contract processing unit 326 has a function of notifying the controlling company terminal 500 identified by the controlling company terminal ID contained in an option application request of a contract notification via the communication unit 330. The controlling company contract processing unit 326 makes a contract notification to the controlling company terminal 500 by including the user terminal ID and information (for example, the user's age and date of taking out insurance) necessary for calculating the user's credit line in the contract notification.

When a death notice indicating that the user has died is acquired from the user terminal 100 via the communication unit 330, the settlement processing unit 325B has a function of notifying the controlling company terminal 500 of the amount of insurance money stored in the storage unit 340 via the communication unit 330. The settlement processing unit 325B can notify the controlling company terminal 500 of the amount of insurance money by including the amount of insurance money in an insurance payment notification.

When a cancellation request indicating cancellation of insurance is acquired from the user terminal 100 via the communication unit 330, the settlement processing unit 325B has a function of notifying the controlling company terminal 500 of the amount of surrender value stored in the storage unit 340 via the communication unit 330. The settlement processing unit 325B can notify the controlling company terminal 500 of the amount of surrender value by including the amount of surrender value in an insurance payment notification.

### [2-3. Function Configuration of Controlling Company Terminal]

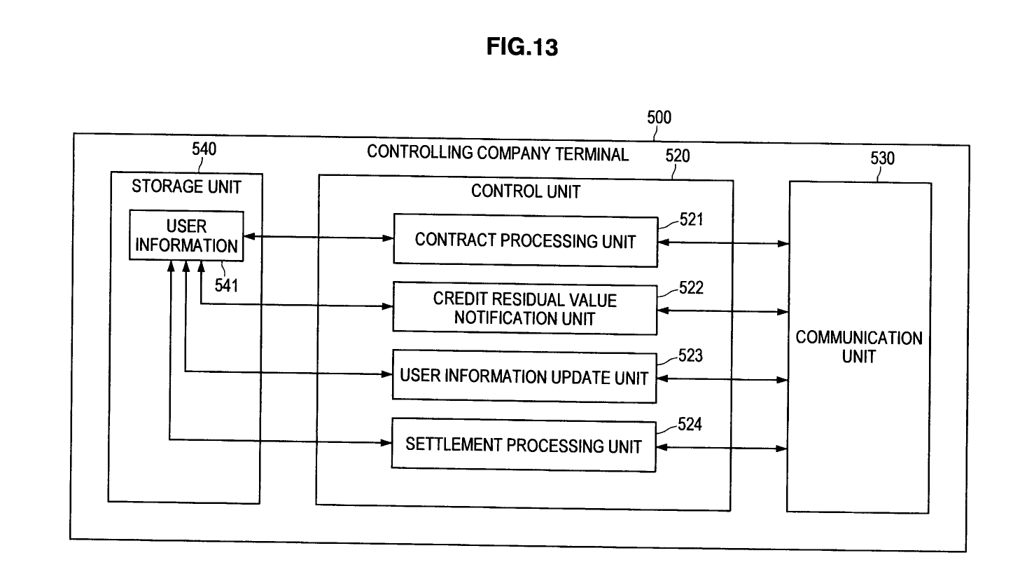

FIG. 13 is a diagram showing the function configuration of a controlling company terminal according to the second embodiment of the present invention. The function configuration of a controlling company terminal according to the second embodiment of the present invention will be described with reference to FIG. 13.

As shown in FIG. 13, the controlling company terminal 500 according to the second embodiment of the present invention mainly includes a control unit 520, a communication unit 530, and a storage unit 540. These units will be described below.

The control unit 520 has a function of controlling the operation of the controlling company terminal 500 and mainly includes a contract processing unit 521, a credit residual value notification unit 522, a user information update unit 523, and a settlement processing unit 524. The control unit 520 is constituted of, for example, a CPU and RAM and the CPU expands a program stored in an HDD or semiconductor memory into the RAM and executes the program to realize the function thereof.

The contract processing unit 521 has a function of acquiring a contract notification from the insurance company terminal 300B via the communication unit 530. As described above, the contract notification contains the user terminal ID and information (for example, the user's age and date of taking out insurance) necessary for calculating the user's credit line and the contract processing unit 521 can cause the storage unit 540 to store the information. Moreover, when a premium receipt notification is acquired from the insurance company terminal 300B via the communication unit 530, the contract processing unit 521 has a function of updating the premium paid period stored by the storage unit 540.

The credit residual value notification unit 522 has a function similar to that of the credit residual value notification unit 323 held by the insurance company terminal 300A according to the first embodiment of the present invention. Therefore, the description of the function provided by the credit residual value notification unit 522 is omitted.

The user information update unit 523 has a function similar to that of the user information update unit 324 held by the insurance company terminal 300A according to the first embodiment of the present invention. Therefore, the description of the function provided by the user information update unit 523 is omitted.

The settlement processing unit 524 has a function of acquiring an insurance payment notification from the insurance company terminal 300B via the communication unit 530. When an insurance payment notification is acquired, the settlement processing unit 524 also has a function of notifying the sales company terminal 200 of a residual value settlement notification via the communication unit 530. When an insurance payment notification is acquired, the settlement processing unit 524 also has a function of notifying the user terminal 100 of an insurance residual value payment notification via the communication unit 530.

If, for example, the amount of insurance money is contained in the insurance payment notification, the settlement processing unit 524 can notify the user terminal 100 of an amount obtained by subtracting the purchase price from the amount of insurance money by including the amount in the insurance residual value payment notification. A technique to consider a service charge acquired by the controlling company can also be considered. When a service charge acquired by the controlling company is considered, the settlement processing unit 524 may notify the user terminal 100 of an amount obtained by subtracting the purchase price and further subtracting the service charge by the controlling company from the amount of insurance money by including the amount in the insurance residual value payment notification. In this manner, the controlling company can also make a profit.

If the surrender value is contained in the insurance payment notification, the settlement processing unit 524 can notify the user terminal 100 of an amount obtained by subtracting the purchase price from the amount of surrender value by including the amount in the insurance residual value payment notification.

The settlement processing unit 524 can also notify the sales company terminal 200 of an amount obtained by subtracting the partial settlement amount from the purchase price via the communication unit 530. The settlement processing unit 524 can notify the sales company terminal 200 of an amount obtained by subtracting the partial settlement amount from the purchase price by including the amount in a residual value settlement notification.

### [2-4. Configuration Example of User Information Held by Insurance Company Terminal]

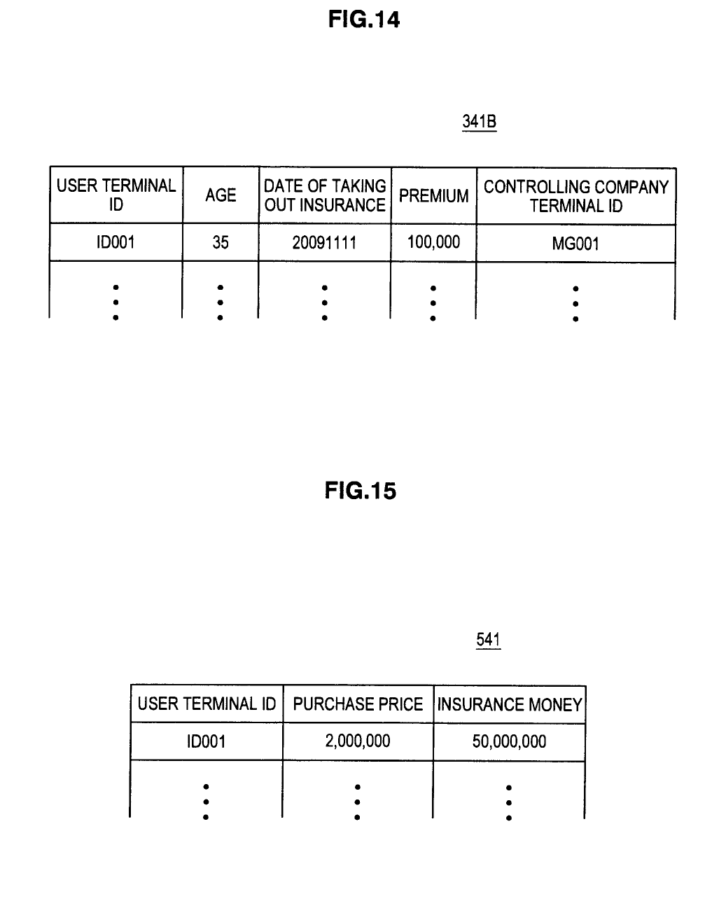

FIG. 14 is a diagram showing a configuration example of user information held by the insurance company terminal according to the second embodiment of the present invention. A configuration example of user information held by the insurance company terminal according to the second embodiment of the present invention will be described with reference to FIG. 14.

As shown in FIG. 14, the user information 341B held by the insurance company terminal 300A according to the second embodiment of the present invention is information in which, for example, the user terminal ID, age, date of taking out insurance, premium, and controlling company terminal ID are associated. However, the configuration of the user information 341B shown in FIG. 14 is only an example and the user information 341B is not limited to such an example.

### [2-5. Configuration Example of User Information Held by Controlling Company Terminal]

FIG. 15 is a diagram showing a configuration example of user information held by the controlling company terminal according to the second embodiment of the present invention. A configuration example of user information held by the controlling company terminal according to the second embodiment of the present invention will be described with reference to FIG. 15.

As shown in FIG. 15, user information 541 held by the controlling company terminal 500 according to the second embodiment of the present invention is information in which, for example, the user terminal ID, purchase price, and insurance money are associated. However, the configuration of the user information 541 shown in FIG. 15 is only an example and the user information 541 is not limited to such an example.

### [2-6. Processing Performed by Insurance Management System (Death Notice or Cancellation Request)]

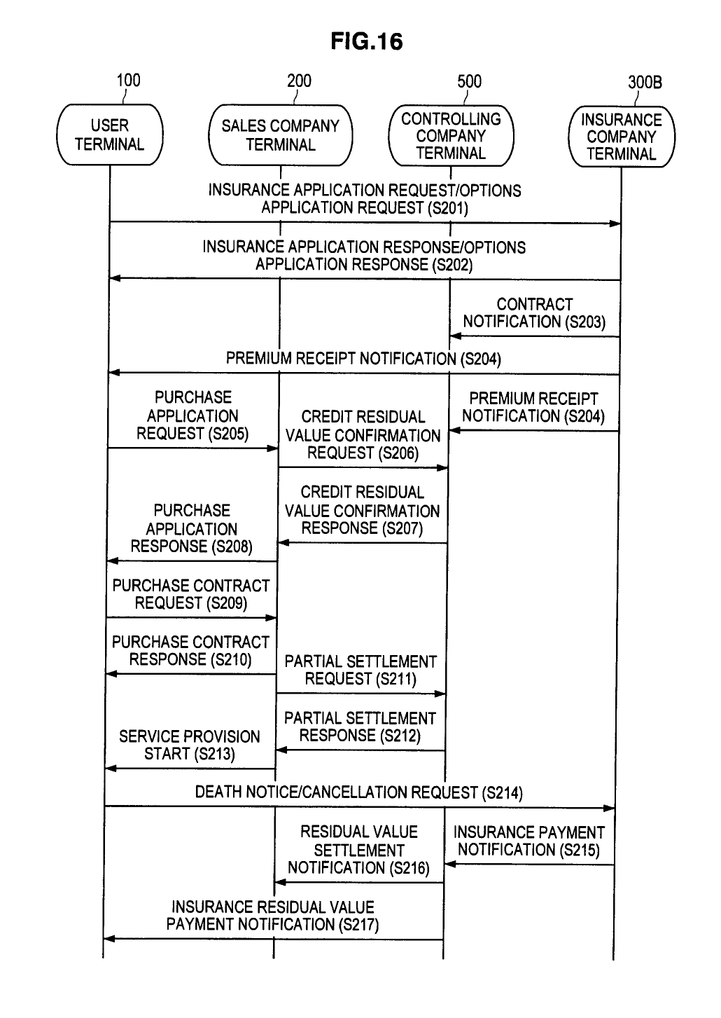

FIG. 16 is a sequence diagram showing the flow of processing (a death notice or cancellation request) performed by the insurance management system according to the second embodiment of the present embodiment. The processing (a death notice or cancellation request) performed by the insurance management system according to the second embodiment of the present embodiment will be described with reference to FIG. 16.

As shown in FIG. 16, the insurance application processing unit 121 of the user terminal 100 notifies the insurance company terminal 300B of an insurance application request (step S201) via the communication unit 130. The insurance application processing unit 121 also notifies the insurance company terminal 300B of an option application request (step S201) via the communication unit 130. The insurance application request and the option application request do not have to be made, as described above, at the same time. The user information registration processing unit 321B of the insurance company terminal 300B acquires the insurance application request via the communication unit 330 and notifies the user terminal 100 of an insurance application response (step S202) via the communication unit 330. As described above, the insurance application response contains, for example, information whether the insurance application request from the user terminal 100 is accepted. The controlling company contract processing unit 326 of the insurance company terminal 300B acquires the option application request via the communication unit 330 and notifies the controlling company terminal 500 of a contract notification (step S203) via the communication unit 330.

The premium receipt notification processing unit 322B of the insurance company terminal 300B notifies the user terminal 100 and the controlling company terminal 500 of a premium receipt notification (step S204) via the communication unit 330. The premium receipt notification acquisition unit 122 of the user terminal 100 acquires the premium receipt notification via the communication unit 130. The contract processing unit 521 of the controlling company terminal 500 also acquires the premium receipt notification via the communication unit 530.

If, for example, as described above, information indicating purchase of an article or service sold by the sales company terminal 200 is acquired from the user via the input unit 110, the purchase processing unit 123 of the user terminal 100 notifies the sales company terminal 200 of a purchase application request (step S205). After acquiring the purchase application request via the communication unit 230, the sales processing unit 221 of the sales company terminal 200 notifies the controlling company terminal 500 of a credit residual value confirmation request (step S206) via the communication unit 230.

When the credit residual value confirmation request is acquired via the communication unit 530, the credit residual value notification unit 522 of the controlling company terminal 500 checks the credit residual value of the user and notifies the sales company terminal 200 of a credit residual value confirmation response (step S207) by including the credit residual value therein via the communication unit 530. After acquiring the credit residual value confirmation response via the communication unit 230, the sales processing unit 221 of the sales company terminal 200 notifies the user terminal 100 of a purchase application response (step S208) via the communication unit 230. As described above, the purchase application response may contain article names selected by the sales processing unit 221 and indicating articles or services of prices equal to or less than the credit residual value or article names of all articles or services that can be sold by the sales company.

When the purchase application response is acquired via the communication unit 130, the purchase processing unit 123 of the user terminal 100 notifies the sales company terminal 200 of a purchase contract request (step S209) via the communication unit 130. The purchase contract request contains, for example, as described above, information for identifying the article or service selected by the user. After acquiring the purchase contract request (step S209) via the communication unit 230, the sales processing unit 221 of the sales company terminal 200 notifies the user terminal 100 of a purchase contract response (step S210) via the communication unit 230. The purchase contract response contains, for example, as described above, information whether the purchase contract request from the user terminal 100 is accepted.

The sales processing unit 221 of the sales company terminal 200 notifies the controlling company terminal 500 of a partial settlement request (step S211) via the communication unit 230. The user information update unit 523 of the controlling company terminal 500 acquires the partial settlement request via the communication unit 530. An employee of the controlling company pays part of the purchase price to the sales company as a partial settlement amount. The user information update unit 523 notifies the sales company terminal 200 of the partial settlement amount by including the amount in a partial settlement response (step S212).

The sales processing unit 221 of the sales company terminal 200 starts the service provision (step S213). It is assumed here that the service is provided to the user terminal 100 by the sales processing unit 221, but the service may be provided to the user by an employee of the sales company and the subject providing the service and the subject receiving the service can appropriately be changed depending on the type of article or service purchased by the user.

When information indicating cancellation of insurance is acquired from the user via the input unit 110, the notification processing unit 124 of the user terminal 100 notifies the insurance company terminal 300B of a cancellation request (step S214). If, after the user dies, information indicating that the user has died is acquired from a beneficiary such as the partner or a child of the user via the input unit 110, the notification processing unit 124 notifies the insurance company terminal 300B of a death notice (step S214) via the communication unit 130.

When a death notice from the user terminal 100 is acquired via the communication unit 330, the settlement processing unit 325B of the insurance company terminal 300B notifies the controlling company terminal 500 of an insurance payment notification including the amount of insurance money stored by the storage unit 340, via the communication unit 330. When a cancellation request from the user terminal 100 is acquired via the communication unit 330, the settlement processing unit 325B of the insurance company terminal 300B notifies the controlling company terminal 500 of an insurance payment notification including the amount of surrender value stored by the storage unit 340.

When the insurance payment notification is acquired via the communication unit 530, the settlement processing unit 524 of the controlling company terminal 500 notifies the sales company terminal 200 of an amount obtained by subtracting the partial settlement amount from the purchase price by including the amount in a residual value settlement notification (step S216) via the communication unit 530. When the insurance payment notification including the amount of insurance money is acquired via the communication unit 530, the settlement processing unit 524 notifies the user terminal 100 of an amount obtained by subtracting the purchase price from the amount of insurance money by including the amount in an insurance residual value payment notification (step S217) via the communication unit 530. When the insurance payment notification including the amount of surrender value is acquired via the communication unit 530, the settlement processing unit 524 notifies the user terminal 100 of an amount obtained by subtracting the purchase price from the amount of surrender value by including the amount in an insurance residual value payment notification (step S217) via the communication unit 530.

As described above, if a service charge acquired by the controlling company is considered, the settlement processing unit 524 may notify the user terminal 100 of an amount obtained by subtracting the purchase price and further subtracting the service charge by the controlling company from the amount of insurance money by including the amount in an insurance residual value payment notification. In this manner, the controlling company can also make a profit.

### [2-7. Processing Performed by Insurance Management System (Service Termination Request)]

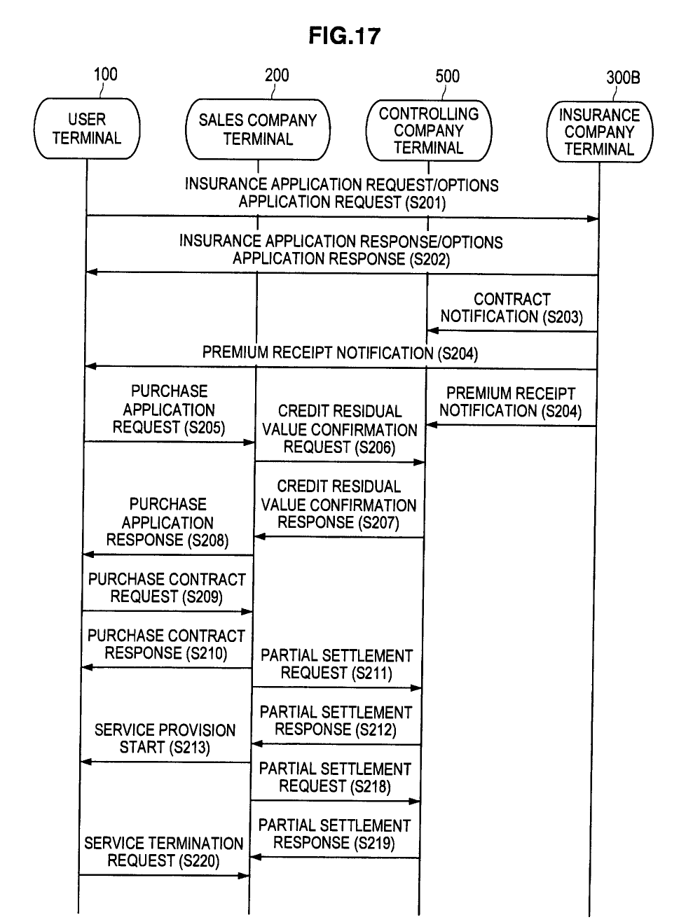

FIG. 17 is a sequence diagram showing the flow of processing (service termination request) performed by the insurance management system according to the second embodiment of the present invention. The processing (service termination request) performed by the insurance management system according to the second embodiment of the present invention will be described with reference to FIG. 17.

If, as described above, the user desires to terminate the provision of an article or service, it is necessary for the user to notify the sales company terminal 200 of a service termination request via the user terminal 100. In such a case, as shown in FIG. 17, the sales processing unit 221 of the sales company terminal 200 notifies the controlling company terminal 500 of a partial settlement request (step S218) in each period in which a usage fee of an article or service arises via the communication unit 230 until a service termination request (step S220) is acquired. Each time a partial settlement request is acquired via the communication unit 530, the user information update unit 523 of the controlling company terminal 500 notifies the sales company terminal 200 of a partial settlement response (step S219) via the communication unit 530.

### 3. Modification

It should be understood by those skilled in the art that various modifications, combinations, sub-combinations and alterations may occur depending on design requirements and other factors insofar as they are within the scope of the appended claims or the equivalents thereof.

### 4. Conclusion

According to the present embodiments, the amount obtained by subtracting purchase prices of articles or services from the insurance money or surrender value is paid during settlement and therefore, articles and services can be purchased with a sense of security without putting up the user's house as a security. Particularly, it becomes possible for users of old age to purchase articles and services with a sense of security.

Advantages gained by each stakeholder in an insurance management system according to the present embodiments are as described below. Because it is difficult to forecast funds necessary for life in the future and therefore, the user is less prone to purchase expensive articles or services. According to an insurance management system in the present embodiments, the user can purchase expensive articles and services with a sense of security. Moreover, the purchase price is limited, which prevents the user from purchasing wasteful articles or services.

For a sales company, the user is more likely to purchase expensive articles and services that are traditionally difficult to sell so that sales of expensive articles and services can be promoted.

For an insurance company, life insurance will be used effectively so that the surrender ratio can be suppressed. The user can purchase articles or services by using part of the insurance money or surrender value as a benefit of the life insurance, which enables the insurance company to differentiate insurance products of the company from those of other companies so that the amount of insurance money can be set still higher.

For a beneficiary, there is a disadvantage of a decreased amount receivable, but the user can obtain articles or services effectively while the user is alive, thereby advantageously reducing loads on the beneficiary who takes care of the user. This effect is particularly conspicuous when articles or services that can be purchased by the user are related to nursing care or medical care.

For a controlling company terminal according to the second embodiment, a service charge can be levied by paying an amount obtained by subtracting the purchase price and further subtracting the service charge by the controlling company from the amount of insurance money to the beneficiary. In this manner, the controlling company can also make a benefit. In the first embodiment, part of the insurance money or surrender value is directly paid from the insurance company to the sales company, but restrictions may be imposed on payment of insurance money for legal reasons or the like. In the second embodiment, the insurance money or surrender value is paid from the insurance company to a trusted controlling company, which divides the received insurance money or surrender value between the sales company and beneficiary. Therefore, an advantage of being able to prevent restrictions from being imposed on payment of insurance money for legal reasons or the like can be gained.

The present application contains subject matter related to that disclosed in Japanese Priority Patent Application JP 2009-274912 filed in the Japan Patent Office on Dec. 2, 2009, the entire content of which is hereby incorporated by reference.

What is claimed is:

1. An insurance company terminal comprising:
a communication unit that performs communication with a sales company terminal;
a storage unit that stores an amount of insurance money settled when a user dies;
a user information update unit that acquires a price of an article or service purchased by the user as a purchase price from the sales company terminal via the communication unit and causes the storage unit to store the purchase price; and
a settlement processing unit that subtracts the purchase price from the amount of the insurance money stored by the storage unit.

2. The insurance company terminal according to claim 1,
wherein the user information update unit causes the storage unit to store part of the purchase price acquired from the sales company terminal as a partial settlement amount, and
the settlement processing unit subtracts the partial settlement amount from the purchase price stored by the storage unit.

3. The insurance company terminal according to claim 2, further comprising:
a credit residual value notification unit that calculates a credit line of the user, calculates a credit residual value by subtracting the purchase price stored by the storage unit from the calculated credit line, and notifies the sales company terminal of the calculated credit residual value via the communication unit.

4. The insurance company terminal according to claim 3,
wherein the storage unit stores the amount of surrender value settled when the user cancels insurance and further stores a period in which the user has paid a premium as a premium paid period, and
the credit residual value notification unit calculates a value that does not exceed the amount of surrender value based on the amount of the surrender value stored by the storage unit, the premium paid period, and the partial settlement amount as the credit line.

5. The insurance company terminal according to claim 4,
wherein the storage unit further stores an investment yield k, and
if the credit line is Z′, the amount of the surrender value Z, the partial settlement amount Y′, and the premium paid period t,
the credit residual value notification unit calculates the credit line Z′ by a following formula (1):
Z′=(Z−Y′)×(1+k)^{t} (1)

6. The insurance company terminal according to claim 4,
wherein the storage unit further stores a risk factor of the user, and
the credit residual value notification unit calculates the credit line based on the risk factor further stored by the storage unit.

7. The insurance company terminal according to claim 4,
wherein the storage unit further stores survival information of a partner, which is information indicating whether a partner of the user is alive, and
the credit residual value notification unit calculates the credit line based on the survival information of the partner further stored by the storage unit.

8. The insurance company terminal according to claim 4,
wherein the surrender value is calculated based on the premium the user pays in each predetermined period and the premium pair period.

9. The insurance company terminal according to claim 1,
wherein the communication unit further performs communication with a user terminal, and
the settlement processing unit notifies the user terminal of the amount obtained by subtracting the purchase price from the amount of the insurance money via the communication unit when a death notice indicating that the user has died is acquired from the user terminal via the communication unit.

10. The insurance company terminal according to claim 2,
wherein the user information update unit acquires the partial settlement amount from the sales company terminal via the communication unit, and
the settlement processing unit notifies the sales company terminal of the amount obtained by subtracting the partial settlement amount from the purchase price via the communication unit.

11. A controlling company terminal comprising:
a storage unit;
a communication unit that performs communication with a sales company terminal and an insurance company terminal;
a contract processing unit that acquires an amount of insurance money settled when a user dies from the insurance company terminal via the communication unit and causes the storage unit to store the amount of the insurance money;
a user information update unit that acquires a price of an article or service purchased by the user as a purchase price from the sales company terminal via the communication unit and causes the storage unit to store the purchase price; and
a settlement processing unit that subtracts the purchase price from the amount of the insurance money stored by the storage unit.

12. An insurance management method, comprising the steps of:
acquiring a price of an article or a service purchased by a user as a purchase price from a sales company terminal via a communication unit by a user information update unit of an insurance company terminal including a communication unit that performs communication with the sales company terminal, a storage unit that stores an amount of insurance money settled when the user dies, the user information update unit, and a settlement processing unit;
causing the storage unit to store the purchase price by the user information update unit; and
subtracting the purchase price from the amount of the insurance money stored by the storage unit by the settlement processing unit.

13. An insurance management method, comprising the steps of:
acquiring an amount of insurance money settled when a user dies from an insurance company terminal via a communication unit by a contract processing unit of an insurance company terminal including a storage unit, a communication unit that performs communication with a sales company terminal and the insurance company terminal, the contract processing unit, a user information update unit, and a settlement processing unit;
causing the storage unit to store the amount of the insurance money by the contract processing unit;
acquiring a price of an article or a service purchased by the user as a purchase price from the sales company terminal via the communication unit by the user information update unit;
causing the storage unit to store the purchase price by the user information update unit; and
subtracting the purchase price from the amount of the insurance money stored by the storage unit by the settlement processing unit.

14. An insurance management system comprising a user terminal, a sales company terminal, and an insurance company terminal,
wherein the user terminal includes:
a communication unit that performs communication with the sales company terminal;
an input unit that accepts input of article identification information for identifying an article or a service purchased by a user; and
a purchase processing unit that notifies the sales company terminal of the article identification information whose input is accepted by the input unit via the communication unit,
the sales company terminal includes:
a communication unit that performs communication with the insurance company terminal;
a storage unit storing article information in which the article identification information and a price of the article or the service identified by the article identification information are associated; and
a sales processing unit that acquires the price corresponding to the article identification information from the article information and notifies the insurance company terminal of the price via the communication unit, and
the insurance company terminal includes:
a communication unit that performs communication with the sales company terminal;
a storage unit that stores an amount of insurance money settled when the user dies;
a user information update unit that acquires the purchase price from the sales company terminal via the communication unit and causes the storage unit to store the purchase price; and
a settlement processing unit that subtracts the purchase price from the amount of the insurance money stored by the storage unit.

15. An insurance management system comprising a user terminal, a sales company terminal, an insurance company terminal, and a controlling company terminal,
wherein the user terminal includes:
a communication unit that performs communication with the sales company terminal;
an input unit that accepts input of article identification information for identifying an article or a service purchased by a user; and
a purchase processing unit that notifies the sales company terminal of the article identification information whose input is accepted by the input unit via the communication unit,
the sales company terminal includes:
a communication unit that performs communication with the insurance company terminal;
a storage unit storing article information in which the article identification information and a price of the article or the service identified by the article identification information are associated; and
a sales processing unit that acquires the price corresponding to the article identification information from the article information and notifies the insurance company terminal of the price via the communication unit,
the insurance company terminal includes:
a communication unit that performs communication with the controlling company terminal;
a storage unit that stores an amount of insurance money settled when the user dies; and
a controlling company contract processing unit that notifies the controlling company terminal of the amount of the insurance money via the communication unit, and
the controlling company terminal includes:
a storage unit;
a communication unit that performs communication with the sales company terminal and the insurance company terminal;
a contract processing unit that acquires the amount of the insurance money from the insurance company terminal via the communication unit and causes the storage unit to store the amount of the insurance money;
a user information update unit that acquires the purchase price from the sales company terminal via the communication unit and causes the storage unit to store the purchase price; and
a settlement processing unit that subtracts the purchase price from the amount of the insurance money stored by the storage unit.
